(19) United States
(12) Patent Application Publication
(10) Pub. No.: US 2007/0266130 A1
(43) Pub. Date: Nov. 15, 2007

(54) A System and Method for Presenting Offers for Purchase to a Mobile Wireless Device

(75) Inventors: Arie Mazur, Toronto (CA); Vadim Fux, Waterloo (CA)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignee: Simpera Inc., Toronto (CA)

(21) Appl. No.: 11/383,049

(22) Filed: May 12, 2006

(51) Int. Cl. G06F 15/173

(52) U.S. Cl. 709/223; 705/26

(57) ABSTRACT

The present invention relates to a system and method for presenting offers for goods and services and facilitating payments for the goods and services through the use of a mobile wireless device such as a cellular telephone. This is accomplished through the use of a mobile client stored on the mobile wireless device. Payments for goods or services may be made directly from mobile wireless device by the user of the mobile wireless device. These payments are reconciled with financial institutions or the mobile servers of other users by a system server. Payments may be to a merchant or to another user of a mobile wireless device. Payments may be initiated through a wireless network connected to the Internet or through the use of Near Field Communications between wireless mobile devices.

### BACKGROUND OF THE INVENTION

The use of mobile wireless devices such as mobile phones, personal digital assistants, laptops and other computing devices is growing rapidly throughout the world. These devices are also providing greater functionality with increasing computing power. Many applications have been developed to make use of mobile wireless devices including accessing the Internet, which allows the user much of the functionality of a traditional wired system. With this ability to access the Internet, comes the possibility for a user of a mobile wireless device to locate and purchase content, goods and services directly through the use of a mobile wireless device. It now also now possible to push offers of content, goods and services for purchase to a mobile wireless device to allow a user to accept an offer to purchase and transfer the needed funds electronically. The present invention is directed to the pushing of such offers of content, goods and services for purchase.

### SUMMARY OF THE INVENTION

The present invention is directed to a method for presenting an offer from a second party to a first party, both of said second party and said first party registered with a system server comprising the steps of:

receiving said offer from said second party, filtering said offer for content and distribution and storing said offer in said system server;

sending said offer to said first party via a mobile client resident on a mobile wireless device and storing information on said offer in said mobile client;

upon said first party accepting said offer, confirming said acceptance with said first party via said mobile client;

upon confirming said acceptance, said system server transferring payment for said offer from said first party to said second party and receiving confirmation from said second party; and

sending confirmation of said transferring of payment to said first party to complete a transaction.

The present invention is further directed to a system for presenting an offer from a second party to a first party, both of said second party and said first party registered with a system server comprising:

means for receiving said offer from said second party, means for filtering said offer for content and distribution and storing said offer in said system server;

means for sending said offer to said first party via a mobile client resident on a mobile wireless device and storing information on said offer in said mobile client;

means for upon said first party accepting said offer, confirming said acceptance with said first party via said mobile client;

means for upon confirming said acceptance, said system server transferring payment for said offer from said first party to said second party and receiving confirmation from said second party; and

means for sending confirmation of said transferring of payment to said first party.

The present invention is also directed to a computer readable medium containing computer instructions to implement the method of claim 1.

### BRIEF DESCRIPTION OF THE DRAWINGS

For a better understanding of the present invention, and to show more clearly how it may be carried into effect, reference will now be made, by way of example, to the accompanying drawings which aid in understanding an embodiment of the present invention and in which:

FIG. 1 is a block diagram illustrating a system utilizing an embodiment of the present invention;

FIG. 2 is a block diagram of the components of a system server;

FIG. 3 is a block diagram of the components of a mobile client resident on a mobile wireless device;

FIG. 4 is a block diagram of the components of an application server;

FIG. 5 is a flowchart illustrating the process of pushing offers from an offer provider;

FIG. 6 is a flowchart illustrating the process of a user accepting an offer;

FIG. 7 is a flowchart illustrating the process of downloading a mobile client;

FIG. 8 is a flowchart illustrating the process of receiving money to a mobile wireless device;

FIG. 9 is a flowchart of the process of topping up a third party account;

FIG. 10 is a flowchart of the process of a user initiating acceptance of an offer through Near Field Communication;

FIG. 11 is a flowchart of the process of loading tokens on a mobile wireless device;

FIG. 12 is a flowchart of the process of purchasing from a smart unattended terminal;

FIG. 13 is a flowchart of the process of accepting an offer from a dumb unattended terminal;

FIG. 14 is a flowchart of the process of presenting aggregated offers to a user; and

FIG. 15 is a flowchart of the process of utilizing a mail in rebate coupon.

### DETAILED DESCRIPTION OF EMBODIMENTS OF THE INVENTION

To aid the user in understanding the invention, we provide a few preliminary definitions:

i) Offer—an offer to purchase content, tickets, goods, services, to top up a third party account, or to pay bills.

ii) Mobile Wireless Device—an electronic device that communicates through a wireless protocol. Examples would be a Personal Digital Assistant (PDA) or a cell phone.

iii) Mobile Client—a system resident in a mobile wireless device that allows for the transfer of funds, the display and purchase of offers, the display of purchase confirmation and the display of transaction history.

iv) User—the person in possession of the mobile wireless device containing the mobile client. In this case they are a registered user as they system is aware of them. Other users may be not registered, for example those who may receive email from the system.

v) Merchant—There are two types of merchants, a mobile merchant and an offer provider both of which are registered with the system.

vi) Mobile Merchant—a merchant who has a mobile client installed on their wireless mobile device.

vii) Offer provider—a merchant who can either submit a specific offer to a specific user or a group of offers for future delivery to users selected by the system server.

viii) Third party account—a prepaid account for a service such as a mobile phone bill which needs to be paid periodically or “topped-up”.

ix) System Server—a control system connecting users with merchants.

x) Smart Unattended terminal—a device that obtains information from a mobile client through the use of Near Field Communication (NFC). An example would be an automated device that monitors entry and exit to a parking lot or another type of vending device.

xi) Dumb unattended terminal—a device that provides an offer through means such as Radio Frequency Identification (RFID) to a mobile client through the use of NFC. An example would be an advertising poster that provides an offer to purchase music.

xii) Terminal server—a server connected to a smart unattended terminal and communicating with a system server.

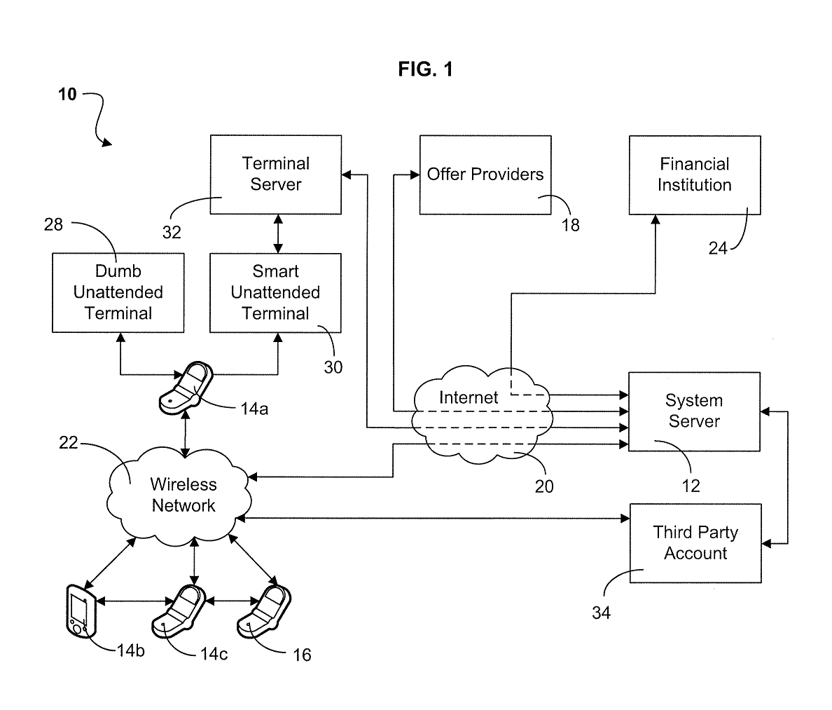

Referring to FIG. 1 a block diagram illustrating a system utilizing an embodiment of the present invention is shown generally as 10. At the heart of system 10 is system server 12. System server 12 serves as the central control for system 10. It aids in arranging purchases between users and merchants, transferring funds between users, and the pushing of offers. It also arranges for the delivery of purchases and the settlement of funds. System server 12 is connected to a plurality of financial institutions 24 for the purpose of verifying users, and accessing and moving the funds between users and merchants.

Mobile merchants 16 are merchants that are known to system server 12, in other words they are registered with system server 12. Mobile merchants have a mobile client installed on their mobile wireless device. This allows a mobile merchant 16 to push immediate offers to buy goods or services directly to a mobile client resident on a mobile wireless device 14a, 14b, or 14c, that are also registered with system 10. A mobile merchant 16 connects to a mobile wireless device 14a, 14b or 14c via wireless network 22.

Offer providers 18 are merchants registered with system server 12. Examples of offer providers 18 may include: information carriers, online stores, content providers, and ticket providers who provide offers to specific user or a group of users. Offer providers 18 may have a separate channel, accessible to the mobile client of a user under the brand name of the offer provider and encapsulating their offers under the name of the offer provider. In addition offer providers 18 can send a specific offer to a specific user, for example an offer to top up their account for phone usage.

A third party account 34 is an account associated with a user such as their telephone usage account. This may be directly topped up by a user without the need to buy and use a prepaid card.

System server 12 interacts with mobile wireless devices 14a, 14b, 14c, mobile merchants 16, offer providers 18, financial institution 24, terminal server 32, and third party account 34 through a network 20 such as Internet and a wireless network 22. Wireless network 22 may utilize formats of communication such as GPRS (General Packet Radio Service), CDMA (Code Divisional Multiple Access), UMTS (Universal Mobile Telecommunications System), infrared, Bluetooth, or Wi-Fi. Internet 20 and wireless network 22 serve only as an example of a network that may be utilized for communication between the components of system 10.

Dumb unattended terminal 28 pushes information to the mobile client of a user via NFC for an offer to purchase an item, which the mobile client then passes on to the system server for more information. Smart unattended terminal 30 accepts an offer to purchase an item directly from the mobile client for an item such as a transit ticket or payment for parking.

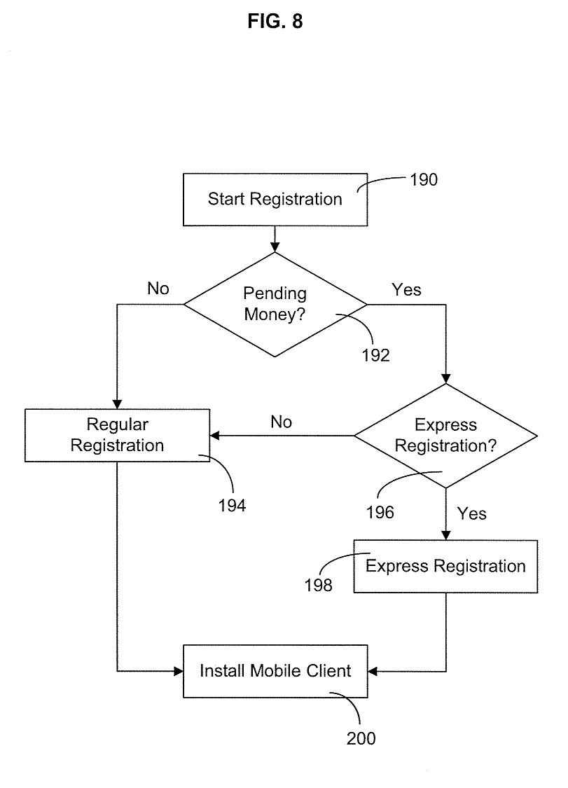

In one use of the present invention a user 14b may transfer funds to another user 14c. For example if user 14c is paying for a group restaurant bill, user 14b may transfer the payment for their portion to user 14c. User 14c may then make use of the funds. This is described in more detail with reference to FIG. 8.

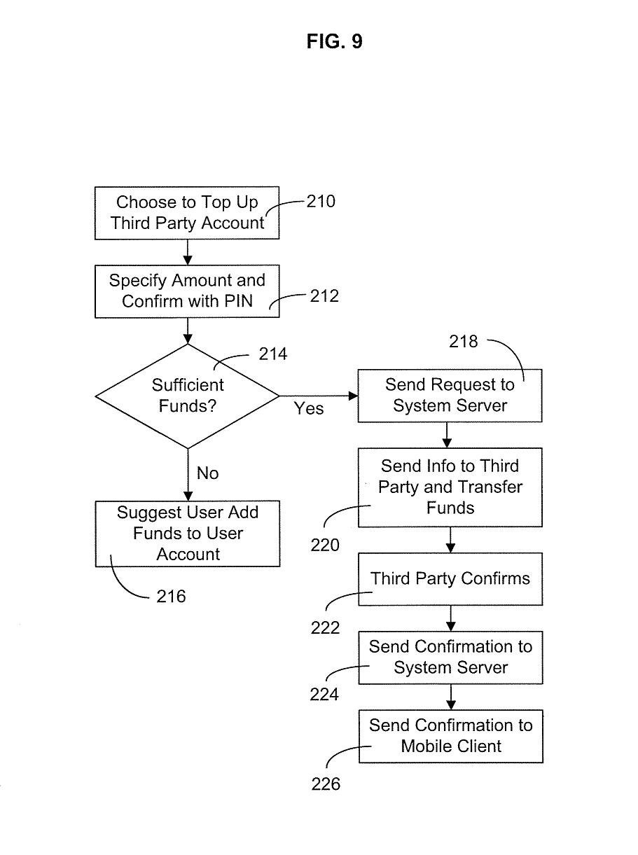

Another use of the present invention permits a user to add money to a third party account, for example a mobile phone use account. This is discussed in more detail with reference to FIG. 9.

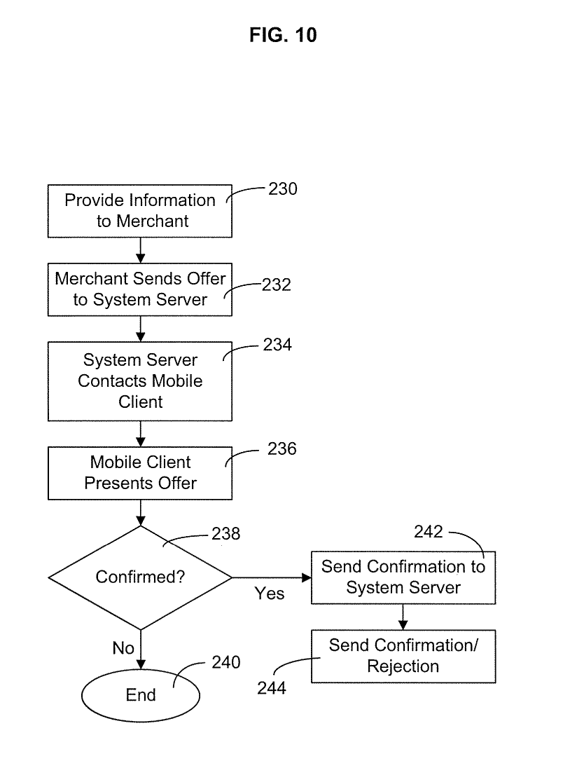

In another use of the present invention a mobile merchant 16 may utilize a mobile wireless device containing a mobile client to obtain user identification, such as a mobile telephone number or a user alias, by NFC without a user providing billing information verbally, from the mobile wireless device of a user 14c. In this case user 14c would bring the mobile wireless device close to the mobile wireless device of mobile merchant 16 to initiate a transaction. This is described in more detail with reference to FIG. 10.

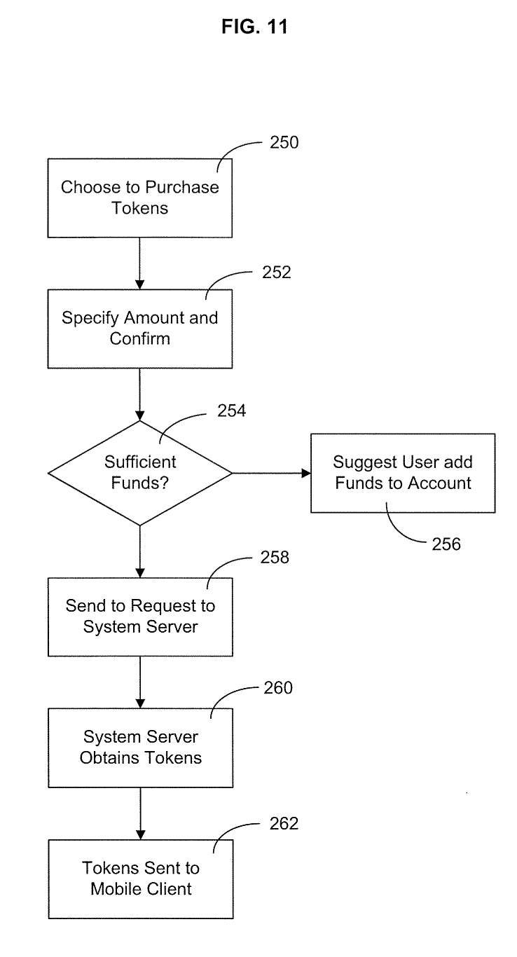

A variation of topping up a third party account would be to allow the user to obtain digital tokens from a transportation authority which would be stored on their wireless mobile device for use with a smart unattended terminal 30. This is discussed in more detail with reference to FIG. 11.

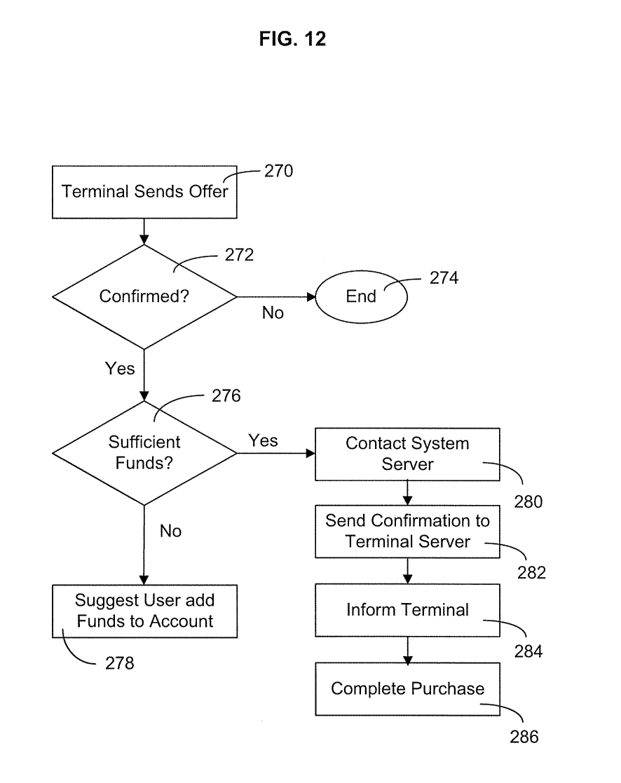

In other use of the present invention a user establishes a connection with a smart unattended terminal 30 to purchase a ticket to a facility (such as a parking lot or public transit) from a mobile wireless device that is in proximity to the smart unattended terminal 30 through the use of NFC. In the case of providing a ticket the smart unattended terminal 30 would then grant access to the facility to the user. This is described in more detail with reference to FIG. 12.

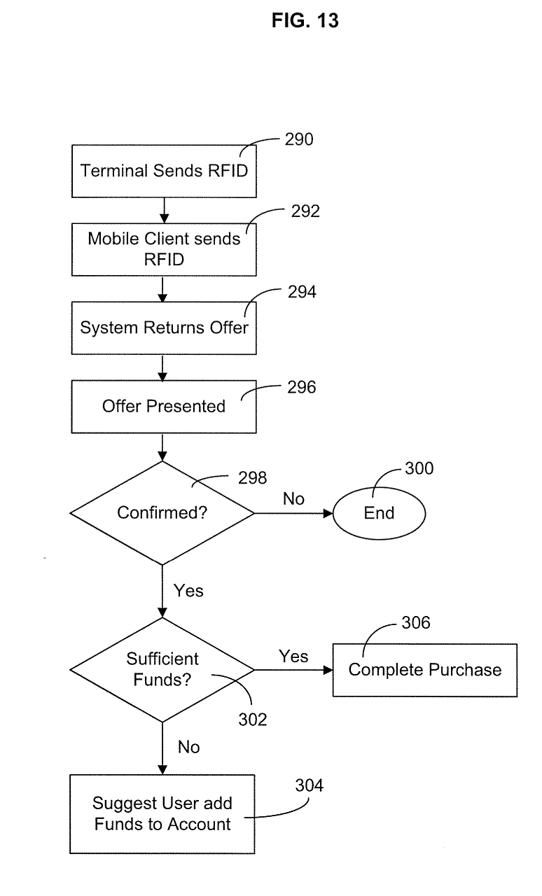

In another use of the present invention, a user may make use of their mobile wireless device 14a by bringing it within proximity of a dumb unattended terminal 28 to communicate through the use of Near Field Communication (NFC). In this situation dumb unattended terminal 28 would contain a means for identifying itself to mobile wireless device 14a, for example a Radio Frequency Identification (RFID) chip. An example of dumb unattended terminal 28 would be an advertising poster with an embedded RFID chip pushing an offer to buy music of the band advertised in the poster to the mobile client on the mobile wireless device 14a of the user. This process is described in more detail with reference to FIG. 13.

In another use of the present invention the system server 12 may collect offers published on the Internet from merchants who are not registered with the system server. It then aggregates these offers and presents them to user through a WAP/HTTP aggregated proxy. This is described in more detail with reference to FIG. 13.

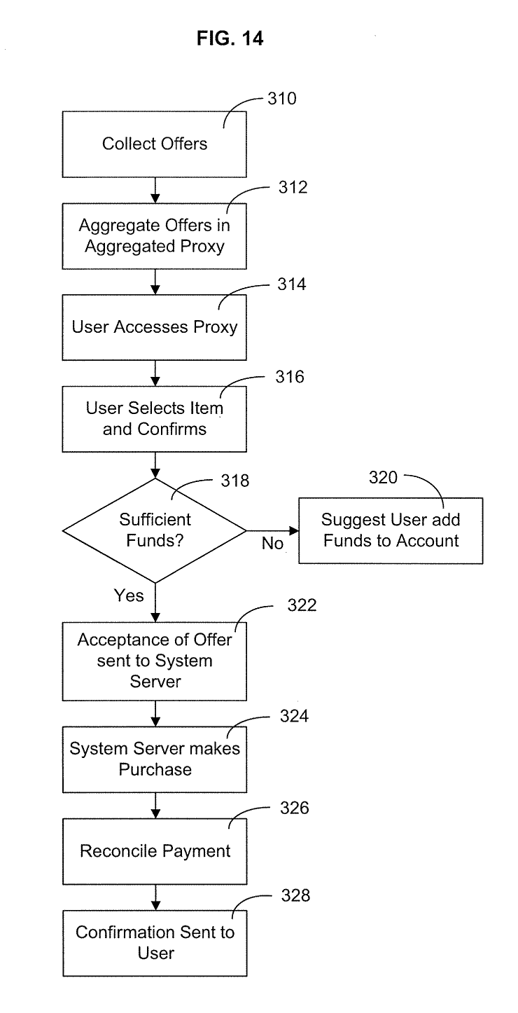

In another use of the present invention, the system server 12 may accept a mail in rebate coupon from a user and present it to a merchant for redemption. This is described in more detail with reference to FIG. 14.

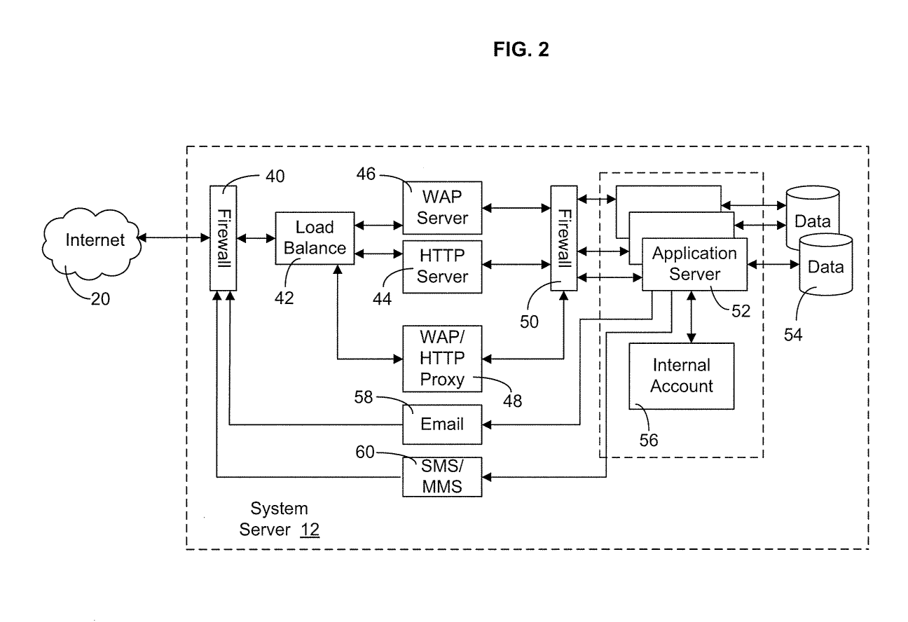

Referring now to FIG. 2 a block diagram of the components of the system server 12 is shown. Internet network 20 allows system server 12 to communicate with the other parts of the system 10. A firewall 40 is utilized to ensure network protection. An optional load balance module 42 may be utilized to balance communications traffic to a plurality of HyperText Transfer Protocol (HTTP) servers 44, Wireless Access Protocol (WAP) servers 46, and WAP/HTTP proxy servers 48. We refer to HTTP, as that is the protocol used for Internet communication. It is not the intent of the inventors to restrict the types of servers 44 and 48 to HTTP it simply serves as an example of one embodiment. A server 44, 46 or proxy 48 in turn communicates through a firewall 50 with an application server 52. An application server 52 handles transactions between users, merchants, terminal servers and financial institutions. An application server 52 is connected to one or more databases 54.

Database 54 contains information about users, such as their bank account number, their address, their phone number, their userid, their PIN, their cryptographic key, historical data on transactions, purchase confirmations and any other information that may be useful to application server 52.

Internal account 56 is an account that contains funds that may be utilized by a user for a purchase. These funds may be accumulated by a user transferring money to the internal account, a second party sending money to the user, or a refund or rebate on a purchase. A user may combine funds from an internal account 56 with other accounts they have with a financial institution 24, such as a credit card or verified checking account. If there are insufficient funds in these combined accounts to make a purchase, the user will be required to add funds to internal account 56 before the purchase can be completed. A merchant will also have an internal account where an account balance is maintained by system 12.

Email module 58 is used by system server 12 to send email to a user who is not a registered user of the system. For example should they be presented with the opportunity to receive funds from a registered user. SMS/MMS module 60 is used to send a message to a user who is not a registered user of the system or to wake up a mobile client on the mobile wireless device of a registered user if their mobile wireless device is inactive to inform them that their reply to a message from system server 12 is required.

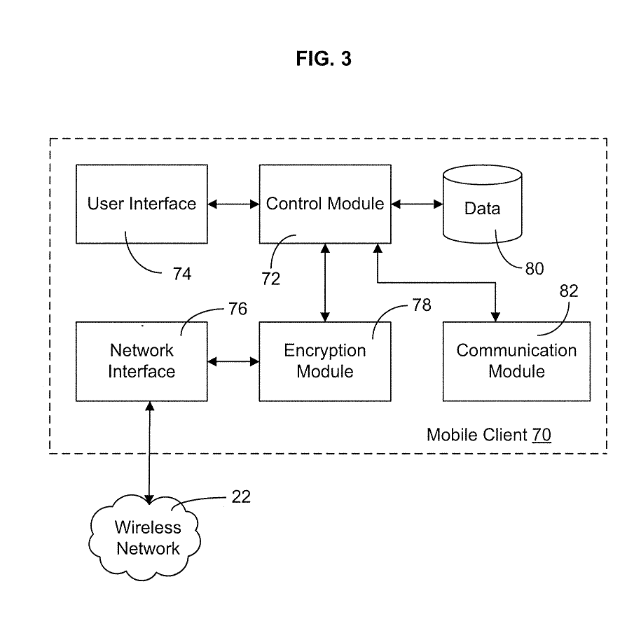

Referring now to FIG. 3 a block diagram of the structure of a mobile client resident on a mobile wireless device is shown. The functions of mobile client 70 are implemented in control module 72. Control module 72 interacts with user interface 74 to display information to a user on the mobile wireless device and receive input from a user. It also works with system server 12 to ensure that information exchanged between mobile client 70 and system server 12 are synchronized to keep both in the same state. For example offers from system server 12 are stored in database 80 and expired offers are deleted and messages between the two are kept current. Also the balance of internal account 56 is stored in database 80 of mobile client 70, this enables the user to determine if they have sufficient funds to purchase an item or if they need to add money to their internal account. Further this permits the authorization of offline transactions in the case where the system server is unavailable and cannot be contacted. In this case the mobile client 70 will be aware of the amount of money the user has. In the case of offline transactions, funds will be reconciled when the system server becomes available which is handled by control module 72 to ensure synchronization of the information stored on system server 12 and mobile client 70.

Network interface 76 provides the logic needed for the mobile wireless device to communicate with wireless network 22 via a protocol of choice. In communications with wireless network 22 network interface 76 makes use of an encryption module 78 for secure communication. Encryption module may make use of any number of data encryption schemes for example RSA, or the Advanced Encryption Standard (AES). In communication via wireless network 22 mobile client 70 utilizes a user cryptographic key stored in database 80 to confirm the identity of a user and to encrypt communications. A Personal Identification Number (PIN) is used to allow the user to access the functionality of the mobile client 70 and to confirm transactions.

Database 80 contains all the data required by the control module 72 to manage transactions and present the user with information on a transaction. Data may include: transaction history, a hash of the user PIN, the user cryptographic key, offers, User Interface display options and available funds.

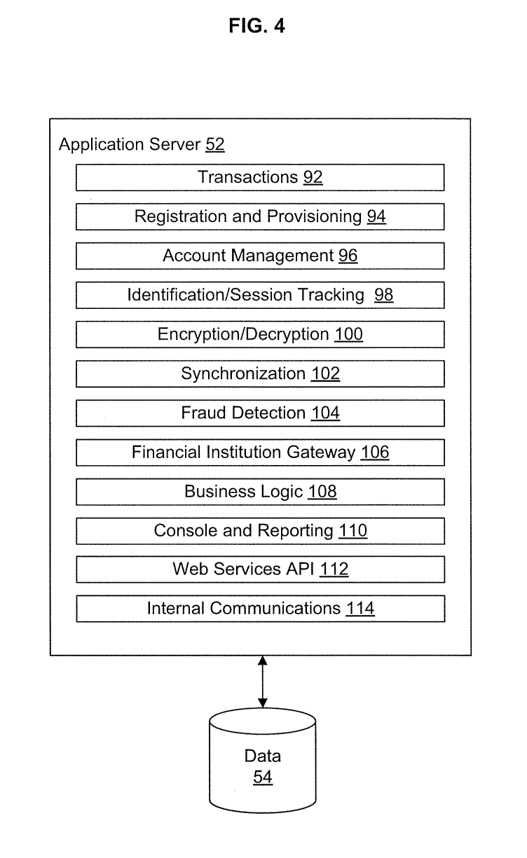

Referring now to FIG. 4 a block diagram of the components of an application server are shown. FIG. 4 illustrates the main components utilized to provide the functionality required in application server 52. Transactions component 92 handles the current transactions with each mobile client 70. Registration and provisioning component 94 handles the registration of users and provides them with a mobile client 70 to be installed on their mobile wireless device. Account management component 96 manages the internal accounts of users and merchants. An internal account is one recognized by the system as belonging to a user or merchant registered with the system. A user or merchant registers with the system by providing personal information and the numbers of the financial accounts. Examples of financial accounts include internal account 56 but may also include a checking account, credit card, or a debit card. Thus it is possible for a user to make a purchase based upon not only the money in their internal account 56 but also to combine monies from other accounts with a financial institution 24. Account management component 96 tracks the money available in each account and reconciles the amounts owed with financial institution 24 after a purchase is made.

In one embodiment a user or merchant may provide a digital photograph of a check to provide account number information during registration. In addition account management component 96 stores all transactions for a user in database 54. Optionally account management component 96 may also support a loyalty system, where loyalty points from transactions may be accumulated based on usage and redeemable by the user. Identification/Session tracking component 98 verifies the identification of a user of the system. Encryption/Decryption component 100 encrypts and decrypts messages to and from application server 52. Synchronization component 102 ensures that communications between the application server 52 and a mobile client 70 are kept synchronized, i.e. the state of communications sent between both should be identical. Fraud detection component 104 monitors for possible fraud.

Financial institution gateway component 106 provides the logic needed to communicate with a financial institution 24 in a financial industry standard manner. Business logic component 108 works with all other components to ensure the correct functioning of the application server 52 in that it acts as a general manager for the modules of application server 52. Console and reporting component 110 allows a system administrator for application server 52 to monitor traffic and generate reports on the communications handled by an application server 52. Web services API 112 permits third parties to utilize the resources of application server 52 through the use of an API. Finally, internal communications component 114 handles the messages exchanged between a mobile client 70 and the application server 52.

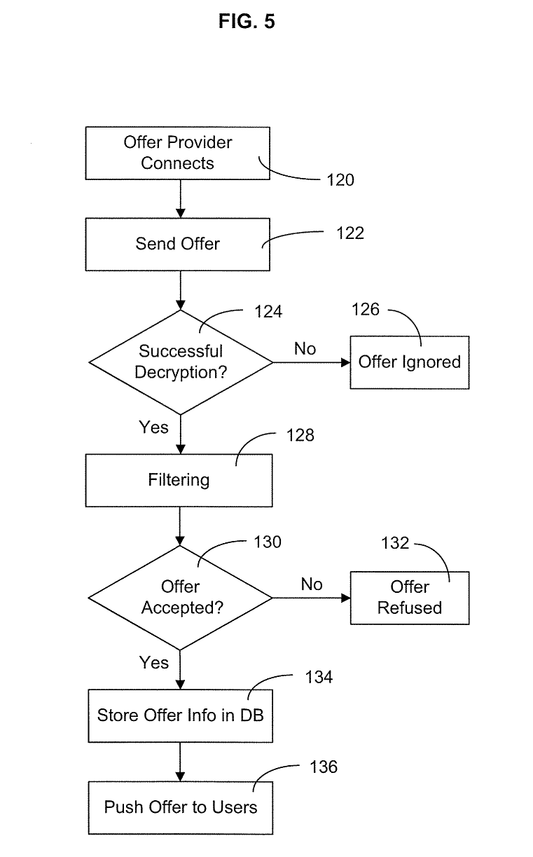

Referring now to the FIG. 5 a flowchart illustrating the process of pushing offers from an offer provider is shown. Beginning at step 120 an offer provider 18 connects to the system server 12. At step 122 one or more offers are sent encrypted using a session encryption key obtained during step 120. At step 124 decryption occurs and a test is made to determine if the decryption was successful. If at step 124 the offer cannot be decrypted then the offer provider is not known to the system and the offer is ignored at step 126 and processing ends. At step 128 each offer is filtered according to details such as the location of the offer in proximity to a user, the buying patterns of a user and types of offers the user has expressed interest in. At this step if there are duplicate offers from different offerers for the same item, a decision may be made not to send the duplicate offer. This decision may be based on a number of criteria, including sending the offer with the lowest price. Further a test is made regarding content, in some cases certain offers may not be applicable to certain users, for example those who are underage or have elected to not receive certain types of offers. At step 130 a test is made to determine if the offer is acceptable based upon the results of step 124. If not, the offer is refused at step 132 and the offerer is informed and processing ends. At step 134 the offer is stored in database 54 and added to a pending list of offers to be sent to selected users. Optionally, for some types of offers, the mobile client 70 is activated from the system server 12 either by opening a connection to the mobile client or sending an SMS message. This would apply to urgent offers, for example a need to pay a phone bill immediately or the mobile wireless device will be disconnected. At step 136 offers are pushed to the mobile client 70 of a user.

The offer may be presented to the user immediately with notification by sound or vibration and popup window or be stored in mobile client database 80 to be browsed at a later time. By way of example, offers may include services, goods, tickets to events or transportation or a suggestion to add funds to an existing third party account.

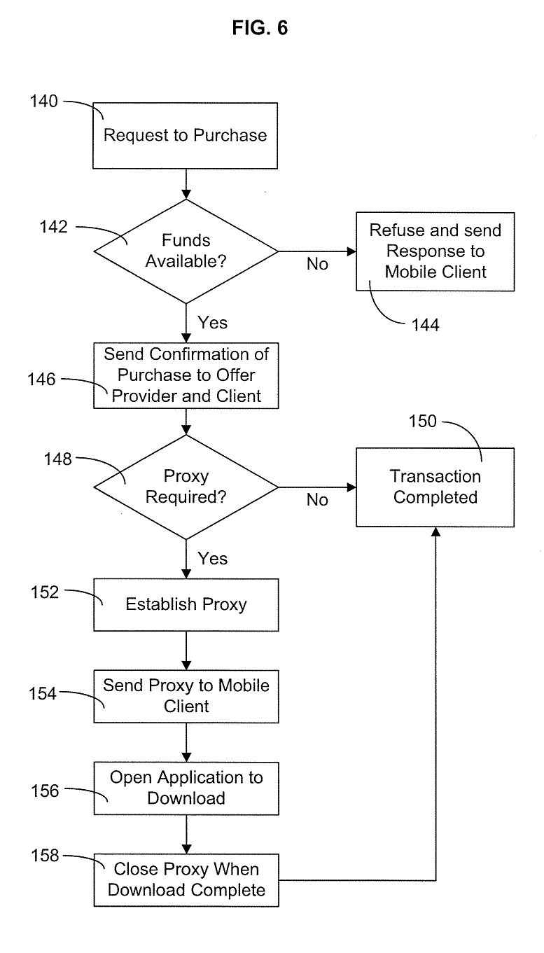

Referring now to FIG. 6 a flowchart for the process of a user completing a purchase is shown. Beginning at step 140 a user decides to purchase an offer. At this step the user also enters their PIN so the identity of the user may be confirmed. Optionally the user may also utilize funds from other financial accounts for the purchase if the internal account 56 does not contain enough money. Once the item is selected and the user has been identified processing moves to step 142. At step 142 a test is made to determine if the user has sufficient funds in their internal account 56 and their accounts with financial institution 24. If not the request to purchase is refused at step 144 and the mobile client of the user is informed of the refusal. If sufficient funds are available, processing moves to step 146 where the purchase is accepted and confirmation is sent both to the offer provider 18 and the mobile client 70 of the user. Optionally the mobile client 70 may also be provided with information on how the user may obtain the item purchased. At step 148 a test is made to determine if the item to be purchased is digital in nature and needs to be downloaded to the mobile wireless device. If this is not the case the transaction is completed at step 150, the funds transferred to the offer provider and the transaction stored in database 54. If the item is digital in nature, application server 52 creates a temporary WAP/HTTP proxy 48 so the item may be downloaded at step 152. At step 154 the URL of the proxy 48 is sent to the mobile client. At step 156 the mobile client opens an application to download the item from the proxy 48. Once the item has been downloaded, application server 52 removes the proxy 48 and the transaction is completed at step 150.

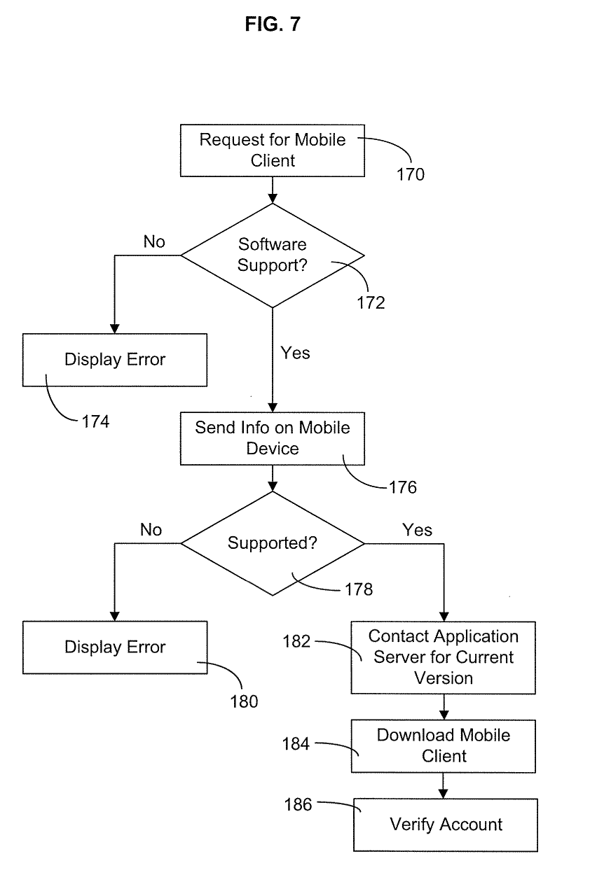

Referring now to FIG. 7 a flowchart illustrating the process of downloading a mobile client 70 is shown. Beginning at step 170 the user of a mobile wireless device requests that a mobile client 70 be downloaded to their mobile wireless device. At this step the user provides information such as: their name, mailing address, the phone number of the mobile wireless device, an alias, bank accounts and credit card information. In an optional embodiment the user may use their mobile wireless device to transmit the image of a check containing a bank account number, rather than entering the number. The user will be asked to confirm the information and agree to a terms of service agreement. The user may also request a mobile client 70 for a specific mobile wireless device they are using or request a generic version. A loader for a generic mobile wireless device is then downloaded to the mobile wireless device by an application server 52. At step 172 a test is made by the loader to determine if the mobile wireless device has the software support required for the downloading of a mobile client 70, for example does it support the needed execution platform, or does it have the required version of the execution platform? If the required support is not available an error message is sent to the mobile wireless device at step 174 with appropriate suggestions such as an upgrade and processing ends. If the required support is available processing moves to step 176 where the loader contacts an application server 52 which in turn performs a check at step 178 to determine if the execution environment and the mobile device capabilities are supported. If not processing moves to step 180 where an error message is provided to the user and processing ends. If the test at step 178 indicates the mobile wireless device is supported, processing moves to step 182 where the application server 52 provides the current version of a mobile client for the mobile wireless device. At this step the application server 52 may have the required device drivers for the mobile client 70 or it may attempt to contact the manufacturer via the Internet for the appropriate device drivers. Processing then moves to step 184 where a mobile client 70 is downloaded to the mobile wireless device. Processing then ends at step 186 where the system server verifies that the one or more bank accounts provided by the user are valid by transferring small amounts of money from their bank accounts into the internal account 56 and asking the user to confirm the transactions.

Referring now to FIG. 8 a flowchart illustrating the process of receiving money to a mobile wireless device is shown. A first user 14b has requested to send money to a second user 14c. In this scenario, user 14c does not have a mobile client 70 installed on their mobile wireless device. Beginning at step 190 a message is pushed to the user 14c. At step 192 the user is asked if they wish to receive the money. If the answer is no, processing moves to step 194 where the user is requested to complete a registration as a user of system server 12 and receive a mobile client 70. If the user declines processing ends. If the user agrees, complete registration details are required for example, (i) user name and address, (ii) financial institution account information, (iii) confirmation of the terms of an agreement for the use of the mobile client 70, (iv) confirmation by the user via the entry of a displayed text image to avoid fraud, and (v) selection of an alias.

If at step 192 the user 14c has agreed to accept the money, they are then asked if they would like express registration. In other words they are not required to provide detailed personal information. If the user declines at step 192, processing moves to step 194 as described above. If the user agrees to express registration processing moves to step 198. At step 198 the user is asked for some minimal information that is not required for a regular registration, for example (i) the telephone number of the mobile wireless device that sent the payment, (ii) the telephone number of their mobile wireless device, (iii) their age, (iv) confirmation of agreeing to the terms of service, (v) confirmation by the user via the entry of a displayed text image to avoid fraud, and (vi) selection of an alias. Should the user not complete the requirements of step 198, processing ends.

If user 14c has completed regular installation 194 or express registration 196 processing moves to step 188. At step 200 a mobile client 70 is installed as shown in FIG. 7.

Referring now to FIG. 9 a flowchart of the process of topping up a third party account is shown. The third party account is known to the system server 12 as belonging to merchant. For example the third party account 34 may be an account with a mobile phone carrier.

In this case when a user wishes to top up a third party account 34, they make a selection of the third party account at step 210. At step 212 the user specifies an amount and provides their PIN. As described with reference to FIG. 6 a user may optionally select the amount from multiple accounts. At step 214 the account balances as stored in the mobile client 70 are checked to determine if there are sufficient funds. If there are not sufficient funds in their accounts the user is suggested to add funds to their internal account 56 at step 216 and processing ends. If the user does have sufficient funds processing moves to step 218 where the system server is contacted with a request to top up the third party account 34. At step 220 system server 12 contacts the owner of the third party account and transfers the funds. At step 222 the third party confirms receipt of the funds and sends the confirmation to the system server 12 at step 224. At step 226 the system server 12 informs the user via mobile client 70 that the amount requested has been added to the third party account 34.

Referring now to FIG. 10 a flowchart of the process of a user initiating acceptance of an offer through Near Field Communication is shown. Beginning at step 230 the user wishes to receive an offer and contacts the smart unattended terminal 30 or mobile merchant 16 by direct NFC connection. If NFC is not available in the case of contacting a mobile merchant 16 the user may provide their alias verbally to the mobile merchant 16 to initiate the transaction. At step 232 the mobile merchant 16 or terminal server 32 contacts the system server 12 with details of the purchase. At step 234 the system server 12 contacts the mobile client 70 of the user and at step 236 the mobile client 70 presents the offer to the user. At step 238 a test is made to determine if the user has accepted the offer. If not processing ends at step 240. If the user does accept the offer, confirmation is sent from the mobile client 70 to the system server 12 at step 242. At step 244 system server 12 sends a confirmation or rejection of the transaction to the user and the mobile merchant 16 or terminal server 32 dependant upon whether there are sufficient funds in the accounts of the user. If the transaction was successful the system server 12 reconciles the funds between the accounts of the user and the internal account of the mobile merchant 16.

Referring now to FIG. 11 a flowchart of the process of loading tokens on a mobile wireless device is shown. Beginning at step 250 the user selects an option to purchase tokens from the user interface 74 of mobile client 70. At step 252 the user enters the number of tokens they wish to purchase and confirms this by entering their PIN. Optionally the user may also enter accounts that they wish to combine monies from for the purchase. For example 50% from their internal account 56 and 50% from their credit card or a bank account with a financial institution 24. Thus, a user has the ability to combine funds from multiple accounts for a single purchase. The information of all user accounts is stored by the mobile client 70 and at step 254 a test is made to determine if the accounts contain sufficient funds to purchase the tokens. If not processing moves to step 256 where it is suggested to the user that they add funds to their internal account 56 and processing ends. If at step 254 it was determined that the user had sufficient funds processing moves to step 258 where the request to purchase is sent to the system server 12 at step 254. At step 260 the system server 12 contacts the merchant selling the tokens and reconciles the funds. Finally at step 262 the digital tokens are sent to the mobile client 70 to be stored in the mobile wireless device of the user for use with a smart unattended terminal 30.

Referring now to FIG. 12 a flowchart of the process of purchasing from a smart unattended terminal is shown. Beginning at step 270 a smart unattended terminal 30 sends a user an offer to purchase an item, for example a ticket to a facility. This offer is sent to the mobile wireless device 14a through the use of NFC. Optionally at step 272 the mobile client 70 may request the user confirm the acceptance of the offer or processing may proceed directly to step 276. If at step 272 the user declines to complete the purchase, processing ends at step 274. At step 276 the mobile client 70 determines if the user has sufficient funds in their accounts as stored in the mobile client. If not processing moves to step 278 where it is suggested to the user that they add funds to their internal account 56 and processing ends. If at step 276 the user does have sufficient funds then at step 280 the mobile client 70 connects to the system server 12 with the details of the offer. At step 282 the system server 12 contacts terminal server 32 to confirm the transaction and reconciles the funds. At step 284 terminal server 32 then informs smart unattended terminal 30 of successful acceptance of the offer, terminal 30 accepts it, which in the case of the terminal 30 providing access to a gated entrance, permits entrance to the user at step 286.

In another embodiment the transaction can happen offline, the transaction occurs between the mobile client 14a and the smart unattended terminal 30 directly. The transaction is than stored in the mobile client 70 and synched to the system server 12 when the connection becomes available, moving the user funds from the internal account 56 to the terminal server 32. This is particularly useful when the connection to a wireless network is not available such as in an underground garage and the amount of the transaction is small relative to the funds available in the internal account.

Referring now to FIG. 13 a flowchart of the process of accepting an offer from a dumb unattended terminal is shown. In this embodiment a dumb unattended terminal 28 contains offer information. An example of dumb unattended terminal 28 would be an advertising poster with an embedded RFID chip pushing an offer to buy music of the band advertised in the poster. Beginning at step 290 a user brings their wireless mobile device 14a in proximity of a dumb unattended terminal 28 to communicate through the use of Near Field Communication (NFC). Once connection has been established, dumb unattended terminal 28 sends information to mobile client 70, perhaps in the form of an RFID tag. At step 292 mobile client 70 sends the information received from the dumb unattended terminal 28 to the system server 12. System server 12 then determines from the information provided the nature of the offer and returns the details of the offer to mobile client 70 at step 294. At step 296 the mobile client 70 presents the details of the offer to the user. Processing then moves to step 298 where the user confirms acceptance of the offer. If the user declines, processing ends at step 300. If the user does accept the offer processing moves step 302 where a test is made to determine if there are sufficient funds in the accounts of the user as stored in their mobile client 70. If there are not sufficient funds processing moves to step 304 where it is suggested to the user that additional funds be added to their internal account 56. If the test at step 302 was successful, processing moves to step 306 and the system server 12 debits the account of the user and credits the account of the offer provider, sending the shipment information to the offer provider and purchase confirmation to the user.

Referring now to FIG. 14 a flowchart of the process of presenting aggregated offers to a user is shown. Beginning at step 310 the system server 12 collects offers from various companies that provide goods are services on the Internet. These offers are collected for a specific user based upon their previous buying history. At step 312 the offers are formatted and provided to the user with link to purchase the item in an aggregated WAP/HTTP proxy. At step 314 the user accesses the aggregated WAP/HTTP proxy via the URL for the WAP/HTTP proxy, using the user interface 74 (which contains a WAP/HTTP browser) of mobile device 70. At step 316 the user selects an item to purchase, which triggers the creation of offer by system server 12 which is sent to mobile client 70. The user confirms they want to purchase the item by providing their PIN. At step 318 a test is made of the accounts of the user as stored in the mobile client 70 to determine if they have sufficient funds for the purchase. If not, processing moves to step 320 where it is suggested to the user that additional funds be added to their internal account 56 and processing ends. If the user does have sufficient funds processing moves to step 322 where the details of the offer are sent to the system server 12 by mobile client 70. Next at step 324 the system server contacts the company that advertised the offer and pays for it. At step 326 the system server then debits the internal account 56 for the purchase. At step 328 confirmation of the purchase is sent to the mobile client 70 of the user.

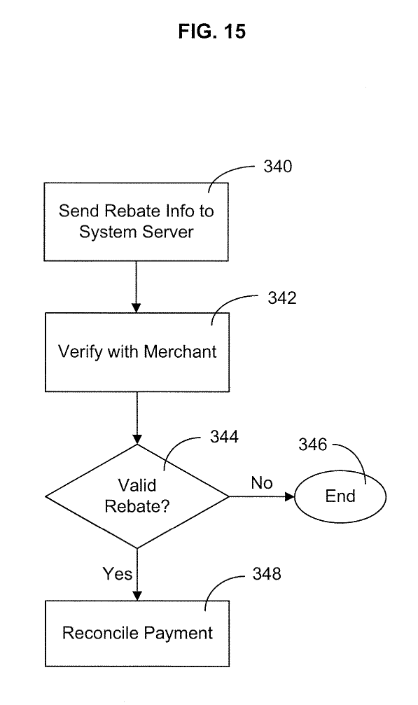

Referring now to FIG. 15 a flowchart of the process of utilizing a mail in rebate coupon is shown. In this situation the user has made a purchase from a merchant and has a coupon that entitles them to a rebate based upon the purchase. Beginning at step 340 the user sends the rebate information to the system server 12. Such information would include the name of the merchant, the product purchased, the amount of the purchase, and a transaction number. If the purchase was made by an offer provided by the system, some of this information may be available to the system server 12 as the transaction will have been stored. At step 342 the system server 12 contacts the merchant with the information needed to redeem the coupon. At step 344 if the merchant has indicated the coupon is not valid processing moves to step 346 where the user is informed of the invalidity of the coupon and processing ends. If at step 344 the coupon has been found to be valid processing moves to step 348 where the internal account of the user is credited for the amount and internal account of merchant is debited for the amount of the coupon.

In this disclosure when we speak of reconciling accounts we mean that payments are debited or credited to internal accounts of a user and a merchant. At periods determined by the implementation, funds owed to a merchant will be deposited in an account owned by the merchant with a financial institution 24.

Additional features that may be implemented in the present invention are:

a) The ability to allow multiple users to use a single internal account for accepting an offer, for example by family members or corporation members and also providing the ability to restrict amounts accessible to certain users.

b) The ability for merchants to associate multiple mobile clients with a single merchant account.

c) When an offer provider 18 sends an offer to the system server 12 they have the option of paying an advertisement fee. This may be a fixed value or it may be a percentage of the selling price for the item. By the payment of an advertising fee the offer submitted by the offer provider 18 is given preferential status by the system, for example it may be sent to a user more quickly or stay active for a longer time than the default. When a user purchases an offer that has an advertisement fee associated with it the system deducts the advertising fee from the payment made by the user before submitting payment to the merchant. Optionally a user may receive part of the advertisement fee in the form of a discount so that when the offer is sent to the user it is discounted by a percentage of the advertisement fee.

d) When confirming acceptance of an offer a user may enter a PIN that initiates a call to a 911 number in the case that the user is being forced to confirm the transaction.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method for presenting an offer from a second party to a first party, both of said second party and said first party registered with a system server comprising the steps of:
receiving said offer from said second party, filtering said offer for content and distribution and storing said offer in said system server;
sending said offer to said first party via a mobile client resident on a mobile wireless device and storing information on said offer in said mobile client;
upon said first party accepting said offer, confirming said acceptance with said first party via said mobile client;
upon confirming said acceptance, said system server transferring payment for said offer from said first party to said second party and receiving confirmation from said second party; and
sending confirmation of said transferring of payment to said first party to complete a transaction.

2. The method of claim 1 wherein said step of sending confirmation includes providing information on how to obtain the item presented in said offer.

3. The method of claim 1 further comprising the one time step of installing said mobile client by downloading a loader application to said mobile device from said system server, said loader application determining a correct version of said mobile client for said mobile device.

4. The method of claim 1 further comprising the step of when said offer is an offer to provide money to a first party not registered with said system server allowing said first party to obtain express registration with said system server.

5. The method of claim 1 wherein said mobile client is uniquely identified by a cryptographic key associated with said mobile wireless device and said first party.

6. The method of claim 1 wherein said filtering comprises the steps of determining if said offer is relevant to said first party based upon the location and buying habits of said first party.

7. The method of claim 1 wherein said filtering comprises the step of removing duplicate offers.

8. The method of claim 1 wherein said offer is targeted to a group of first parties registered with said system server.

9. The method of claim 1 wherein said offer is targeted to a specific first party registered with said system server.

10. The method of claim 9 wherein said offer is an offer to purchase digital tokens that are redeemable by NFC.

11. The method of claim 1 wherein said mobile client is associated with a plurality of financial accounts.

12. The method of claim 1 wherein a plurality of mobile clients are associated with a single internal account.

13. The method of claim 11 wherein said mobile client utilizes funds from a combination of said plurality of financial accounts for a single purchase.

14. The method of claim 1 further comprising the step of establishing a WAP/HTTP proxy containing aggregated offers and allowing said first party to browse through said aggregated offers and select one or more offers.

15. The method of claim 1 wherein if said offer is for a digital item, upon receiving confirmation from said second party, establishing a temporary WAP/HTTP proxy to allow said first party to download said digital item.

16. The method of claim 1 wherein if said system server is unavailable, said second party and said first party establishing connection directly with each other to complete said transaction and upon availability of said system server informing said system server of said transaction.

17. The method of claim 1 wherein said offer is deleted once said offer expires.

18. The method of claim 1 further comprising the step of after sending confirmation, permitting said first party to utilize a mail in rebate coupon and crediting the internal account of said first party for the amount of said rebate coupon.

19. The method of claim 1 further comprising the step of said first party accumulating loyalty points for accepting offers, said loyalty points redeemable by said first party.

20. The method of claim 1 wherein the step of sending confirmation, further comprises the step of notifying said first party via said mobile device through sound or vibration.

21. The method of claim 1 wherein the step of confirming said acceptance includes the step of providing a PIN that mimics said first party accepting and calls an emergency telephone number.

22. The method of claim 3 wherein said installing comprises the step of verification by performing a series of small transactions moving funds from a first party bank account to a internal account within said system server and confirming the amounts of the transactions with said first party.

23. The method of claim 22 wherein said verification provides the option of accepting a digital image of a check to determine a bank account number.

24. A system for presenting an offer from a second party to a first party, both of said second party and said first party registered with a system server comprising:
means for receiving said offer from said second party, means for filtering said offer for content and distribution and storing said offer in said system server;
means for sending said offer to said first party via a mobile client resident on a mobile wireless device and storing information on said offer in said mobile client;
means for upon said first party accepting said offer, confirming said acceptance with said first party via said mobile client;
means for upon confirming said acceptance, said system server transferring payment for said offer from said first party to said second party and receiving confirmation from said second party; and
means for sending confirmation of said transferring of payment to said first party.

25. A computer readable medium containing computer instructions to implement the method of claim 1.
